(19) United States
(12) Patent Application Publication
(10) Pub. No.: US 2013/0169834 A1
(43) Pub. Date: Jul. 4, 2013

(54) PHOTO EXTRACTION FROM VIDEO

(71) Applicants: William S. Herz, Hayward, CA (US); Godfrey Cheng, San Jose, CA (US)

(72) Inventors: William S. Herz, Hayward, CA (US); Godfrey Cheng, San Jose, CA (US)

(73) Assignee: ADVANCED MICRO DEVICES, INC., Sunnyvale, CA (US)

(21) Appl. No.: 13/614,355

(22) Filed: Sep. 13, 2012

Related U.S. Application Data
(60) Provisional application No. 61/581,823, filed on Dec. 30, 2011.

(51) Int. Cl. G06K 9/46; H04N 5/225

(52) U.S. Cl. 348/220.1; 382/190; 348/E05.024

(57) ABSTRACT

A method and system for extracting a still photo from a video signal includes selecting a center-of-mass frame, and correcting erroneous pixel data in the center-of-mass frame using pixel data from temporally offset frames to produce a corrected frame. A plurality of corrected frames is produced by repeating the process and an optimized still photo is extracted from the plurality of corrected frames.

### FIELD OF THE INVENTION

This application is related to video processing.

### BACKGROUND

When a video user wishes to extract a frame of video having high quality as in a still photo (i.e., a single frame of video data), a computer may be employed to process the data. For example, a frame may be exported from an output frame buffer, copied and stored. The stored frame of data can then be converted to a photo format, such as Joint Photographic Experts Group (JPEG), bitmap (BMP), or Graphics Interchange Format (GIF).

There are, however, a variety of artifacts that become noticeable upon pausing (or “freezing”) the frame which corrupt the image. During real-time video viewing or video playback, such artifacts are not perceptible as a single frame may last for only 1/60 of a second, for example. However, when the video is slowed down or stopped for a still frame, the artifacts may be quite visible.

### SUMMARY OF EMBODIMENTS

In one embodiment of some aspects of the of the invention there is described a method for extracting a still photo from a video signal which includes selecting at least one center-of-mass frame from the video signal, where the center-of-mass frame represents a candidate for the still photo, and the selecting is based on input, such as user input, that indicates a frame of interest. Pixel data in the at least one selected center-of-mass frame is corrected using pixel data from temporally offset frames to produce a corrected frame. A plurality of corrected frames is produced by repeating the selecting and the correcting and a still photo is extracted from the plurality of corrected frames based on an image quality assessment the corrected frames.

A system for extracting a still photo from a video signal includes a video capturing system for producing source data, a graphical user interface; and a processing unit configured to receive the source data and to receive input from the graphical user interface. The processing unit is further configured to select at least one center-of-mass frame from the video signal, where the center-of-mass frame represents a candidate for the still photo, and, in a further embodiment, the selecting is based on a user input that indicates a frame of interest. The processing unit is further configured to correct pixel data in the at least one selected center-of-mass frame using pixel data from temporally offset frames to produce a corrected frame. The processing unit repeats the selection and correction of pixel data to produce a plurality of corrected frames. The still photo is extracted by the processing unit from the corrected frames based on an image quality assessment the corrected frames.

A non-transitory computer readable medium has instructions stored thereon that, when executed, perform an extraction of a still photo from a video signal according to the following steps. At least one center-of-mass frame is selected from the video signal, where the center-of-mass frame represents a candidate for the still photo, and the selecting is based on input that indicates a frame of interest. Pixel data is corrected in the at least one center-of-mass frame using pixel data from temporally offset frames to produce a corrected frame. The selecting and the correcting is repeated to produce a plurality of corrected frames. The still photo is extracted from the corrected frames based on an image quality assessment of the corrected frames.

### BRIEF DESCRIPTION OF THE DRAWINGS

FIG. 1 shows an example block diagram of a system configured to extract a still photo from a video signal according to the embodiments described herein;

FIG. 2 shows a flowchart of a method for extracting a still photo from a video signal;

FIG. 3 shows a block diagram of an example device in which one or more disclosed embodiments may be implemented;

FIG. 4A shows a graphical user interface display having various settings for selection by a user for the photo extraction;

FIG. 4B shows a graphical user interface display showing a frames of interest selector and extracted photos; and

FIG. 4C shows a graphical user interface display having settings for selection by a user related to quality of result and processing.

### DETAILED DESCRIPTION OF EMBODIMENTS

A system and method are provided for extracting a still photo from video. The system and method allow a user to select from among various available settings as presented on a display of a graphical user interface. Categories of settings include, but are not limited to, entering input pertaining to known types of defects for the video data, selecting a real-time or a playback mode, video data sample size to be analyzed (e.g., number of frames), identifying blur contributors (e.g., velocity of a moving camera), and selecting various color adjustments. A user interface may also include selection of frames of interest within a video segment from which a still photo is desired. This user interface may provide a result for several iterations of the extraction process, allowing the user to select, display, save and/or print one or more extracted photos. The system may include a processing unit that extracts an optimized photo from among a series of initial extracted photos, with or without user input. The system and method may include user interface to allow the user to have selective control of a sliding scale relationship between quality of result and processing time/processing resource allocation.

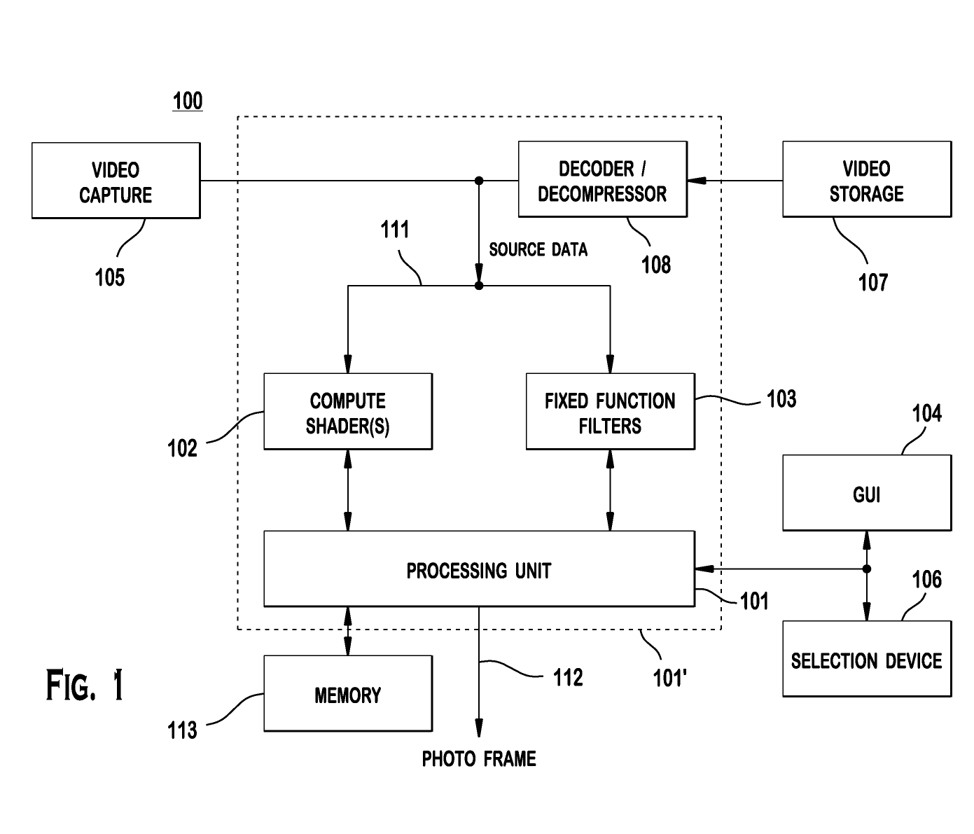

FIG. 1 shows a block diagram of a system 100 configured to perform extraction of a photo from video, including a processing unit 101 (e.g., a central processing unit (CPU), a graphics processing unit (GPU), an accelerated processing unit (APU), or a combination thereof), a compute shader(s) 102, fixed function filters 103, a graphical user interface (GUI) 104, a memory 113, and a selection device 106. The GUI 104 may, for example, include a display for a user to interface with the system 100, which may show setting selectors, video images, and extracted still photos. The display may include touch screen capability. The selection device 106 may include, for example, a keyboard and/or a mouse or other similar selection device, for allowing the user to interface with the system 100.

Source data 111 may be received from a video capturing system 105, such as a video camera. Alternatively, the source data 111 may be received from a video storage device 107 (e.g., a hard drive or a flash memory device) which may playback a video stream (e.g., internet protocol (IP) packets). A decoder or decompressor 108 is used to generate uncompressed pixels that are subsequently filtered for improved quality or clean up from the video storage 107. The improved quality may be achieved by, but is not limited to, deriving using motion vectors. The photo frame 112 is the output of the processing unit 101 following the photo extraction processing. While the compute shader 102, fixed function filters 103, and decoder/decompressor 108 are shown as being separate from the processing unit 101, the processing unit 101 may be configured to include any or all of these units as elements of the processing unit 101 as a single unit 101′.

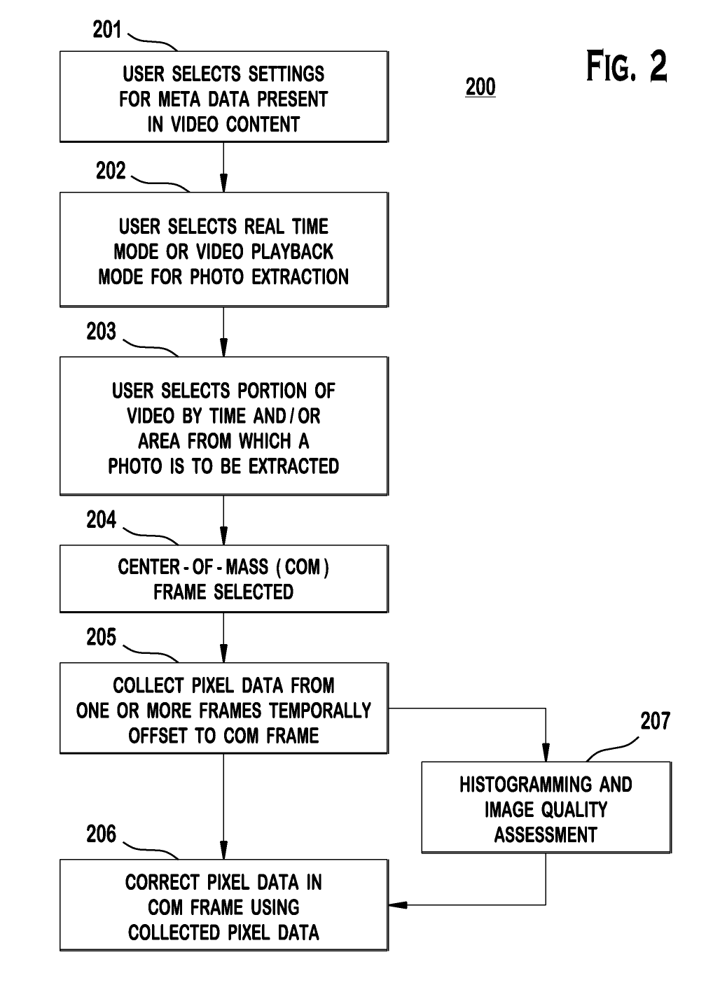

FIG. 2 shows an example flowchart of a method 200 to perform extraction of a still photo from a video signal implemented by the system 100. Using the GUI 104, in step 201, a user may select settings based on metadata present in the video signal data. The GUI 104 may display a set of available settings from which the user may select any one or more of the settings according to known or potential defects or artifacts present in the video signal data. For example, if the video signal data is from an analog tuner board, the user could apply an analog-noise-present designation to be used to adjust correction of such defects during the photo extraction process. Other examples of artifacts that may be potentially present in the video signal data include low bit-rate artifacts, scaling defects, cross luminance, and cross artifacts associated with stored content or digital stream content.

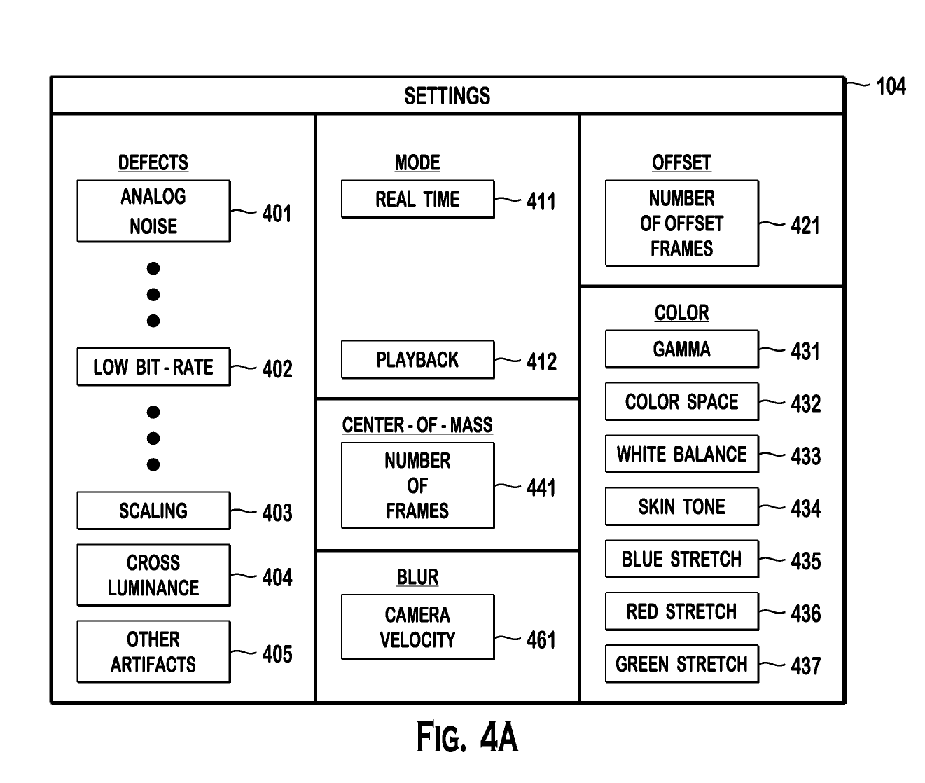

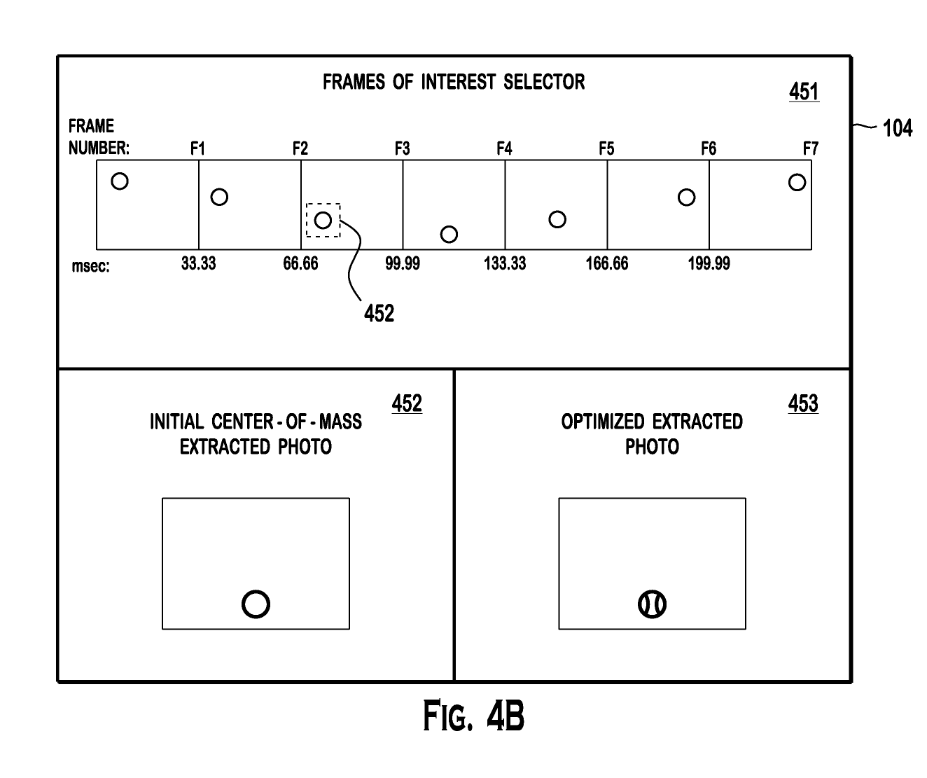

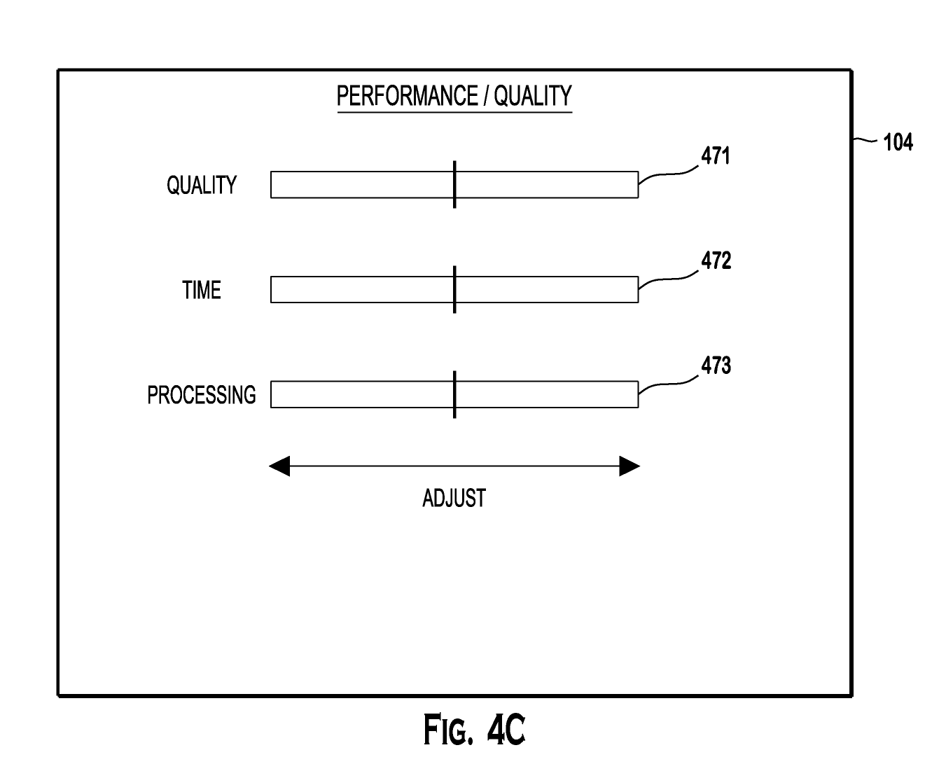

FIG. 4A shows an example of a GUI 104 display having available settings for the user to correct known defects, including, but not limited to, analog noise 401, low bit-rate 402, scaling 403, cross-luminance 404, and other artifacts 405.

The user may designate a real-time mode for photo extraction as shown in step 202, using the GUI 104, which activates the photo extraction processing to occur during real-time operation of the video signal capture. In response to the selection of the real-time mode, a temporary load is added on the processing unit 101 for the photo extraction processing, rather than a sustained load. The processing unit 101 restricts the photo extraction process during the real-time mode to a limited time as minimally needed to extract the still photo so as not to burden the related graphics and processing subsystems. FIG. 4A shows an example of a displayed setting selector for real-time mode 411. Alternatively in step 202, the GUI 104 may present the user with a selection to perform photo extraction during video playback mode 412, without the system load of video decoding, providing full system processing capability during the photo extraction processing. It should be noted that the sequence of steps 201 and 202 is not fixed in the order as shown, and that both steps are optional.

In step 203, the GUI 104 displays frames from which the user may select a single frame or a sequence of frames of interest for the photo extraction, which may be a portion of video data in temporal units. FIG. 4B shows an example of a frames of interest selector 451, where the selection may be based on units of frame numbers (shown as F1-F7) or time (shown as milliseconds). Another alternative for selection includes a standard video time code. In addition, the user may select a particular display area 452 from which to extract a photo, as an array of pixels representing a region of interest for example, using the GUI 104 as shown in FIG. 4B. This may be done using the selection device 106 to select a window of pixels 452 as shown on the display of the GUI 104. The window selection may, for example, include using a mouse to point and click on a first selection point to designate a first corner of the window 452 and then to point and click on a second selection point to designate a second corner of the window 452. Alternatively, the selection may involve a first point and click of the mouse at the first corner of the window 452, followed by dragging a cursor on the display to select the second corner of the window 452 upon release of the mouse. As a result of the window selection, the desired portion of the full frame is selected for further processing to extract the photo, and the pixels in the unselected portion of the frame (i.e., outside of window 452) may be excluded from further processing.

Based on a selected single frame of interest, the processing unit 101 identifies a center-of-mass frame in step 204 within the source video data 111. This center-of-mass frame is a frame that the processor uses to analyze and process the pixel data to extract the photo. The center-of mass frame may be the selected frame-of-interest, or it may be a nearby frame. If the user selects several frames of interest, the processing unit 101 selects the first frame of interest or a nearby frame as a first center-of-mass frame, the second frame of interest or a nearby frame as a second center-of-mass frame, and so on, until all frames of interest are each designated with a corresponding center-of-mass frame. From the multiple center-of-mass frames, the user or the processing unit 101 may select a final center-of-mass frame based on quality or preference of the user.

As an example of a center-of-mass frame, an I-frame in a Moving Picture Expert Group (MPEG) stream may be used for the center-of-mass frame. Alternatively, a frame close to where the user would like to pause (perhaps within a defined threshold number of frames), which has small motion vectors and/or small errors (both of which are specified within the MPEG standard), may be used to select a center-of-mass frame.

Further alternatives to the step 204 selection of a center-of-mass frame include the following. The user may use the GUI 104 to select a single frame based on either the composition of the frame or the timing of the sequence. Alternatively, the user may use the GUI 104 to select a single frame as a first approximation for the center-of-mass frame based on composition or timing (e.g., the image in the frame is compelling in some way as it relates to the image content and/or to a particular moment in time). It may be, however, that the first approximation for the center-of-mass frame has an image quality that is less than desired. For example, the subject matter may not be properly lit, off-centered, clipped and/or blurry. To remedy this, the processing unit 101 may select a nearby frame, as a second center-of-mass frame, which may also have the preferred characteristics of the first center-of-mass frame, but with improved quality (e.g., absence of motion blur and other artifacts). Alternatively, there may be no user intervention in the initial approximation. Instead, the processing unit 101 may select one or more various frames of interest based on a quality parameter, such as where detected eyes of a face in the image are opened, centering of the image subject, size of a detected face, a detected face directly facing the camera or indirectly facing the camera, brightness, and so on. In this alternative, the processing unit 101 is configured as a non-transitory medium having stored instructions, that upon execution, perform algorithms to determine the above quality parameters.

In any of the preceding examples for selecting the center-of-mass frame, the decision may be tiered by spatial aspects and/or temporal aspects of the image within the frame or frames of interest and nearby candidate frames. For example, a first selection may be a frame sequence in which the general composition of the image spatially within the frame has a quality or characteristic of interest, and a second selection may be a single frame within the frame sequence based on a momentary event displayed in the video frame. Alternatively, the tiered decision may be based on temporal aspects before spatial aspects. For example, the first selection may be a frame sequence based on a particular time segment, and the second selection may be a single frame within the frame sequence based on the size, position and/or orientation of the image content within the frame. The spatial aspect decision may also include input from the user having selected a region of interest 452 within the frame, as described above in step 203. Alternatively, the decision may be tiered based on various spatial aspects alone, or based on various temporal aspects alone.

In step 205, pixel data is collected from one or more temporally offset frames previous of the center-of-mass frame and one or more temporally offset frames following the center-of-mass frame for referencing and comparison to determine the artifacts for correction. The number of temporally offset frames from which the processing unit 101 collects pixel data may be adjustable by the processing unit 101 using an optimization algorithm that weighs processing time against quality assessment based on historical results. In addition, the number of offset frames may be a selectable fixed number based on the photo extraction mode setting. For example, if the real-time extraction mode 411 is activated, the processing unit 101 may set a lower number of offset frames which will allow restriction of the entire photo extraction process to an acceptable limited time duration as previously described. This adjustable number may also be selected by the user using offset 421 selector displayed on the GUI 104 as shown in FIG. 4A. For example, the user may select from a displayed range of numbers provided on the GUI 104. The temporally offset frames may or may not be adjacent frames with each other or with respect to the center-of-mass frames. If the number of temporally offset frames includes frames of a different scene than the initial center-of-mass frame, upon detecting the scene change frames, the processing unit 101 is triggered to halt further processing of temporally offset frames, and may also eliminate any collected pixel data obtained from the scene change frames.

In step 206, the compute shaders 102 and/or the fixed function filters 103 perform correction of pixel data to remove the artifacts related to various parameters including, but not limited to: poor color, motion blur, poor deinterlacing, video compression artifacts, poor brightness level, and poor detail. To correct the artifacts, an assessment of motion vectors within the video content is performed, whereby the degree of motion per pixel is established. Processing of pixel motion may include horizontal motion, vertical motion, or combined horizontal and vertical motion. A comparison of the current frame to a previous frame, a next frame, and/or previous and next frames combined, may be performed by the compute shaders 102 and/or fixed function filters 103. The pixel data may be processed to subtract, substitute, interpolate, or a combination thereof, to minimize blur, color, noise, or other aberrations associated with any non-uniform object motion (e.g., an object that is in accelerating or decelerating motion) with respect to uniform motion pixels (e.g., X, Y spatial interpolation, or X, Y spatial interpolation with Z temporal interpolation). Alternatively, pixel data from temporally offset frames may be substituted instead of being subtracted. In the case of interlaced content, a multiple frame motion corrected weave technique may be employed. Techniques which might otherwise take too long for a duration of 1/60 second, may be employed. Techniques such as edge enhancement, intermacro-block edge smoothing, contrast enhancements, etc. may be developed in view of the time constraint. Given that a still image is being processed in this embodiment, more robust but more computationally intensive versions of these same techniques may be applied. The above artifact correction techniques may be constrained to the spatial coordinates of a single frame. In addition, more data within the spatial domain and/or the temporal domain from other frames may be employed. Other techniques that may be applied to remove the artifacts include consensus, substitution, or arithmetic combining operations that may be implemented by, for example, the compute shaders 102 (e.g., using a sum of absolute differences (SAD) instruction), or the fixed function filters 103. Alternatively, the user may selectively adjust motion blur and/or edge corrections while viewing an extracted still photo during a playback photo extraction mode, and save the settings as a profile for future photo extraction processing of a video clip where frames of interest have similar characteristics. For example, in a case where the camera is arranged to move at a certain velocity, such as a camera mounted on a rail system or on a guy wire, the similar characteristics may include camera velocity. The blur and/or edges may then be corrected based on a known camera velocity, and if stored in the profile, subsequent corrections may be easily repeated. The user may make the blur and/or edge correction selections using the GUI 104 at a camera velocity selector 461 as shown in FIG. 4A. The profile may be stored and re-applied as a starting point or default for all future frames of interest.

With respect to color correction, the processing unit 101 may apply any one or more of the following techniques: gamma correction, modification to the color space conversion matrix, white balance, skin tone enhancement, blue stretch, red stretch, or green stretch. Alternatively, the user may selectively apply these color corrections, while viewing an extracted still photo during a playback photo extraction mode, and save the settings as a profile for future photo extraction processing of a video clip where frames of interest have similar characteristics, which may include for example, environment, lighting condition, or camera setting. The user may make the color correction selections using the GUI 104 at the following displayed selectors as shown in FIG. 4A: gamma 431, color space 432, white balance 433, skin tone 434, blue stretch 435, red stretch 436, and green stretch 437. The profile may be stored and re-applied as a starting point or default for all future frames of interest.

In step 207, the processing unit 101 may optionally select another center-of-mass frame temporally offset to the initial center-of-mass frame (for example, if necessitated by an unsatisfactory quality of the processed center-of-mass frame) and may repeat steps 205 and 206 to correct detected artifacts while generating a histogram of the results. Using an image quality assessment of the results, an optimized photo extraction is achieved, and the optimized extracted photo 453 is displayed on a display of the GUI 104 as shown in FIG. 4B. The processing unit 101 may repeat the method 200 for additional temporally offset frames within a range of frames of interest. The number of analyzed center-of-mass frames may be a predetermined fixed number selected by the processing unit 101, or may be a selectable fixed number based on the photo extraction mode setting. For example, if the real-time extraction mode 411 is activated, the processing unit 101 may set a lower number of center-of-mass frames so that the process is restricted to an acceptable limited time duration as previously described. Alternatively, the number of analyzed center-of-mass frames may be a fixed number selected by the user by using a center-of-mass number of frames selector 441 displayed on the GUI 104 as shown in FIG. 4A. As another option for the user, the center-of-mass frames may be selected according to a selection of an entire range of frames as indicated by the user via the GUI 104, such as selecting frames F2-F6 as shown in FIG. 4B.

The processing unit 101 may halt further processing of adjacent frames triggered by a detection of a scene change in the frame sequence, thus indicating that such a frame is not suitable as the center-of-mass frame since the frame does not have an image of interest.

Using this autonomous process, the processing unit 101 may select a “best” choice from the optimized photo extraction. The user may then select the extracted photo based on the initial center-of-mass frame or the optimized result according to user preference by comparing the displayed results on the GUI 104 as shown in FIG. 4B as an initial center-of-mass extracted photo 452 and an optimized extracted photo 453. Alternatively, the processing unit 101 may present the user as a display on the GUI 104 with a set of extracted photos resulting from the multiple iterations, from which the user may select a still photo. For example, in a first extracted photo, the object of interest may include a person, where the person's face is in focus, while in the second extracted photo, the person's feet may be in focus. The user may select from the first and the second extracted photos depending on preference for the area in focus. The GUI 104 may also display a selection option for printing the extracted photo thereby enabling the user print the extracted photo on a connected printer device.

FIG. 4C shows an example of a GUI 104 display having available settings for the user to adjust a selectable quality result versus processing time and processing power. As shown in FIG. 4C, this selectable adjustment example includes but is not limited to a quality selector 471, a time selector 472, and a processing selector 473. The quality selector 471 allows the user to select an adjustment of quality of result for the photo extraction. The time selector 472 allows the user to select an adjustment for the processing time for the photo extraction. The processing selector 473 allows the user to select processing power (or processing resources allocated) corresponding with the photo extraction. Upon display of these selectable adjustments on the GUI 104, the user may for example select a highest quality of result setting using the quality selector 471. In response, the time selector 472 and processing selector 473 indications will be adjusted along the sliding scale as directed by the processing unit 101 according to an assessment of processing time and processing power (or processing unit 101 resources) required to achieve the selected quality. Alternatively, if the user determines after one or more trials at the present adjustment of quality selector 471 that the processing time is excessive, the time selector 472 may be adjusted on the GUI 104 downward to achieve a faster processing for the photo extraction. In response, the processing unit 101 may then adjust the quality selector 471 and processing selector 473 to indicate a quality result and the required processing resources along the sliding scale that correspond with the newly selected setting for the time selector 472. Alternatively, the processing selector 473 may be adjusted on the GUI 104 by the user to control the processing resources consumed by the photo extraction method, if for example, the user determines that other parallel processes are suffering to an undesirable degree after one or more trials at a previous adjustment setting of quality, time or processing. In response to a selected adjustment of the processing selector 473, the other selectors 471 and 472 may be automatically adjusted by the processing unit 101 to reflect the corresponding settings. Other variations are also available according to the adjustments shown in FIG. 4C, such as allowing the user to select settings of two of the three selectors 471, 472, 473, whereby the processing unit then adjusts the indication for the remaining selector corresponding to the user's two selector settings. Processing resources associated with the processing unit 101 controlled by the processing selector 473 may include a number of the compute shaders 102, an allocated memory size of memory 113, and/or a number of APUs utilized by the processing unit 101. Another variation includes displaying one or two of the selectors 471, 472, 473 on the GUI 104, allowing the user to adjust one or two of the quality, time and/or processing selector settings.

The GUI 104 displays as shown in FIG. 4A and FIG. 4B are sample representations, and may be implemented according to various combinations of screen displays where each item as shown may be presented alone or in various other combinations to suit the user's preference or to facilitate processing the photo extraction under various conditions as needed. [Discuss selectable axis for Q, Time, processing power.]

It should be noted that combinations of the above techniques may be used to address additional artifacts in the video signal frame, such as algorithms that may be used in a GPU post-processing system. In the context of the embodiments described herein, the algorithms may be modified in complexity or in processing theme, consistent with processing of photo pixels rather than a video stream with a dynamic nature. For example, but not by way of limitation, the following may be modified: number of filter taps, deeper edge smoothing or softening (for correcting a jagged edge caused by aliasing), selecting photo color space in place of video color space or vice-versa (i.e., a matrix transform may be used to remap the pixel color coordinate of the first color space to that of the other color space). The result is a photo extracted from the video signal input where the extracted photo has quality equivalent to or superior to one obtained by using a digital photo device.

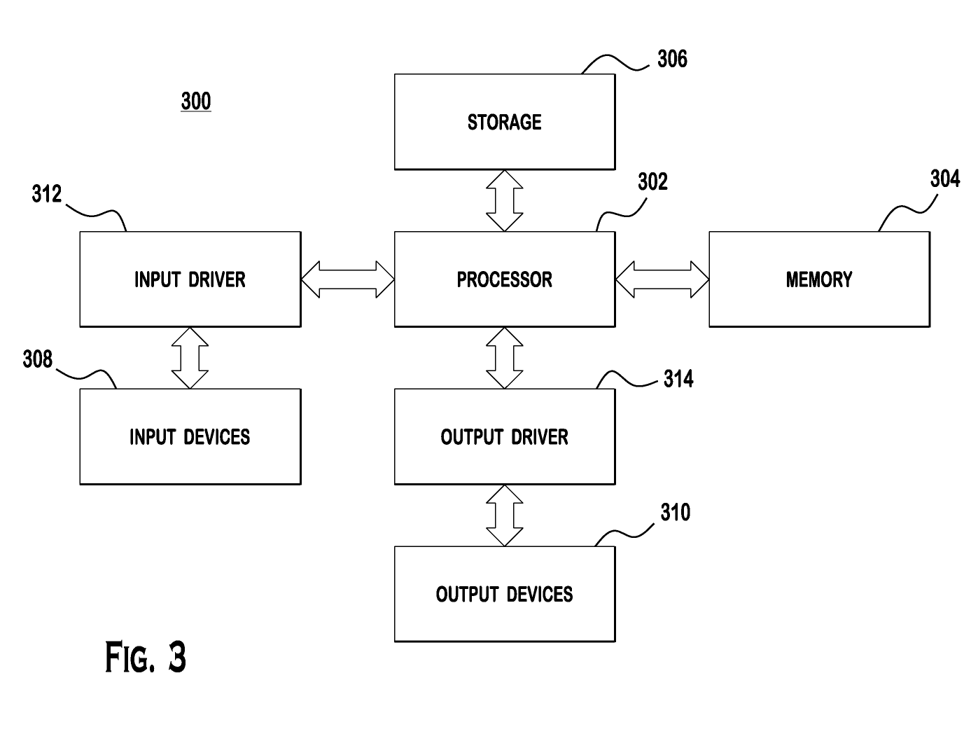

FIG. 3 is a block diagram of an example device 300 in which one or more disclosed embodiments may be implemented. The device 300 may include, for example, a camera, a computer, a gaming device, a handheld device, a set-top box, a television, a mobile phone, or a tablet computer. The device 300 includes a processor 302, a memory 304, a storage 306, one or more input devices 308, and one or more output devices 310. The device 300 may also optionally include an input driver 312 and an output driver 314. It is understood that the device 300 may include additional components not shown in FIG. 3.

The processor 302 may include a central processing unit (CPU), a graphics processing unit (GPU), a CPU and GPU located on the same die, or one or more processor cores, wherein each processor core may be a CPU or a GPU, as in an accelerated processing unit (APU). The processor 302 may be configured to perform the functions as described above with reference to the processing unit 101/101′ shown in FIG. 1, and may include the compute shader 102, the fixed function filters 103, and/or the decoder/decompressor 108 as well. The memory 304 may be located on the same die as the processor 302, or may be located separately from the processor 302. The memory 304 may include a volatile or non-volatile memory, for example, random access memory (RAM), dynamic RAM, or a cache.

The storage 306 may include a fixed or removable storage, for example, a hard disk drive, a solid state drive, an optical disk, or a flash drive, similar to the video storage device 107 shown in FIG. 1. The input devices 308 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The input devices 308 are analogous to the video capture device 105, the GUI 104 and the selection device 106 as described above with reference to FIG. 1. The output devices 310 may include a display, a speaker, a printer, a haptic feedback device, one or more lights, an antenna, or a network connection (e.g., a wireless local area network card for transmission and/or reception of wireless IEEE 802 signals), which correspond with a display component of the GUI 104 shown in FIG. 1.

The input driver 312 communicates with the processor 302 and the input devices 308, and permits the processor 302 to receive input from the input devices 308. The output driver 314 communicates with the processor 302 and the output devices 310, and permits the processor 302 to send output to the output devices 310. It is noted that the input driver 312 and the output driver 314 are optional components, and that the device 300 will operate in the same manner if the input driver 312 and the output driver 314 are not present.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the present invention.

The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method performed by a processing unit for extracting a still photo from a video signal, comprising:
selecting at least one center-of-mass frame from the video signal, where the center-of-mass frame represents a candidate for the still photo, and the selecting is based on input that indicates a frame of interest;
correcting pixel data in the at least one selected center-of-mass frame using pixel data from temporally offset frames to produce a corrected frame;
repeating the selecting and the correcting to produce a plurality of corrected frames; and
extracting the still photo from the corrected frames based on an image quality assessment the corrected frames.

2. The method as in claim 1, further comprising the processing unit adjusting a number of the temporally offset frames using an optimization algorithm that weighs processing time against quality assessment based on historical results.

3. The method as in claim 1, wherein the processing unit selects the center-of-mass frame from a frame sequence of the video signal that includes the frame of interest, and according to a tiered decision based on spatial aspects of the image within the frame sequence.

4. The method as in claim 1, wherein the processing unit selects the center-of-mass frame from a frame sequence of the video signal that includes the frame of interest, and according to a tiered decision based on temporal aspects of the image within the frame sequence.

5. The method as in claim 1, wherein the processing unit selects the center-of-mass frame from a frame sequence of the video signal that includes the frame of interest, and according to a tiered decision based on spatial aspects and temporal aspects of the image within the frame sequence.

6. The method as in claim 1, further comprising:
displaying available settings for selection by a user for encoding metadata related to potential defects in the video signal content; and
receiving selected settings from the user;
wherein the correcting pixel data includes decoding the metadata and adjusting the correction of pixel data based on the decoded metadata.

7. The method as in claim 1, further comprising:
adjusting a number of temporally offset frames from which the pixel data is collected;
detecting a scene change in a selected temporally offset frame; and
triggering a halt of collecting further pixel data from temporally offset frames.

8. The method as in claim 1, wherein the correcting pixel data includes:
assessing motion vectors within the video signal data;
establishing a degree of motion per pixel; and
correcting blur associated with an object in the center-of-mass frame using one of subtraction, substitution or interpolation.

9. The method as in claim 8, further comprising employing a multiple frame motion corrected weave to subtract blur for interlaced video content, wherein on a condition that weaving introduces aliasing, using interpolation to eliminate the aliasing.

10. The method as in claim 1, wherein the correcting pixel data includes at least one of applying consensus, substitution, or arithmetic combining operations to remove artifacts from the center-of-mass frame.

11. The method as in claim 1, further comprising receiving a user input that selects a real-time photo extraction mode and restricting the photo extraction method to a limited time as minimally needed to extract the photo.

12. The method as in claim 1, further comprising displaying the extracted still photo on a display.

13. The method as in claim 1, further comprising:
displaying at least one adjustment selector including quality of result, processing time, or processing power; and
adjusting, in response to at least one selection by a user, at least one setting on a corresponding adjustment selector.

14. The method as in claim 1, wherein the frame of interest input is provided as a user input.

15. A system for extracting a still photo from a video signal, comprising:
a video capturing system for producing source data;
a graphical user interface; and
a processing unit configured to receive the source data and to receive input from the graphical user interface;
wherein the processing unit is further configured to:
select at least one center-of-mass frame from the video signal, where the center-of-mass frame represents a candidate for the still photo, and the selecting is based on input that indicates a frame of interest;
correct pixel data in the at least one selected center-of-mass frame using pixel data from temporally offset frames to produce a corrected frame;
repeat the selection and correction of pixel data to produce a plurality of corrected frames; and
extract the still photo from the corrected frames based on an image quality assessment the corrected frames.

16. The system as in claim 15, wherein the processing unit is further configured to select the center-of-mass frame from a frame sequence of the video signal that includes the frame of interest, and according to a tiered decision based on spatial aspects and temporal aspects of the image within the frame sequence.

17. The system as in claim 15, wherein the processing unit is further configured to:
adjust a number of temporally offset frames from which the pixel data is collected;
detect a scene change in a selected temporally offset frame; and
trigger a halt of collecting further pixel data from temporally offset frames.

18. The system as in claim 15, further comprising at least one compute shader for correcting the pixel data using a sum of absolute differences instruction.

19. The system of claim 15, wherein the graphical user interface includes a display for displaying the extracted still photo.

20. A non-transitory computer readable medium having instructions stored thereon that, when executed, perform an extraction of a still photo from a video signal according to the following steps:
selecting at least one center-of-mass frame from the video signal, where the center-of-mass frame represents a candidate for the still photo, and the selecting is based on input that indicates a frame of interest;
correcting pixel data in the at least one center-of-mass frame using pixel data from temporally offset frames to produce a corrected frame;
repeating the selecting and the correcting to produce a plurality of corrected frames; and
extracting the still photo from the corrected frames based on an image quality assessment of the corrected frames.
